(19) United States
(12) Patent Application Publication
(10) Pub. No.: US 2015/0120484 A1
(43) Pub. Date: Apr. 30, 2015

(54) SYSTEM AND METHOD FOR MARKETING AND SELLING AUCTION ITEMS

(71) Applicant: ALTESO LLC, Langhorne, PA (US)

(72) Inventors: Yury Kaganov, Churchville, PA (US); Maksim V. Repik, Ivyland, PA (US)

(21) Appl. No.: 14/524,764

(22) Filed: Oct. 27, 2014

Related U.S. Application Data
(60) Provisional application No. 61/895,605, filed on Oct. 25, 2013.

(51) Int. Cl. G06Q 30/08; G06Q 30/06

(52) U.S. Cl. CPC G06Q 30/08; G06Q 30/0631; G06Q 30/0641
USPC 705/26.3

(57) ABSTRACT

A method for marketing and selling auction items includes the steps of providing a system for generating a customized auction website to facilitate access to an inventory of auction items, receiving a request from a subscriber of the system to generate a customized auction website to provide access to the inventory of auction items for a user of the customized auction website, and generating the customized auction website according to subscriber specified parameters. The method further includes the steps of receiving a bid request for an auction item from a user of the customized auction website and communicating a response to the bid request to the user via the customized auction website. A method is for use by auction houses and a plurality of buyers, where identity of the auction house remains unknown to the customer of a buyer, and identity of the customer remain unknown to the auction house.

### CROSS-REFERENCE TO RELATED APPLICATIONS

This application claims priority to U.S. Provisional Patent Application No. 61/895,605, titled “System and Method for Marketing and Selling Auction Items,” which was filed on Oct. 25, 2013, and which is expressly incorporated by reference herein in its entirety.

### TECHNICAL FIELD

The disclosed material relates generally to systems and methods for expanding the potential purchasing audience for an auction selling items. More particularly the disclosed material relates to systems and methods for online auctions that provide for intermediate buyers to purchase auctioned items and resell such items to end users of the item.

### BACKGROUND

Many types of products offered for sale on an open market can provide uniform value to buyers from one article to the next article. For such products that do not vary from one article to another, such as commodities and many consumer goods, a seller can assign a single price to all articles that is generally acceptable to buyers in the market. However, such a single price model is not readily applicable to certain products offered for sale. For example, the value of unique products, such as pre-owned or customized products, may vary from one article to another. For example, pre-owned durable goods, such as vehicles, appliances, or industrial equipment, may vary greatly in price even if two such durable goods are of equivalent age and were identical at the time of manufacture. Factors that can affect the value, and thus the market price, of pre-owned durable goods are wear and tear, damage, repair history, use history (i.e., such as automobile mileage), after market modifications, and the like. Because it is difficult and inefficient for sellers to individually analyze and value each such unique article, sellers look to more efficient methods of ascertaining the fair market value of such unique products.

One common method of determining a fair market value for unique goods is to sell the good through an auction. In an auction, potential buyers can each individually evaluate the product and the many factors that affect the price of the product and bid accordingly. An auction, however, may not always provide a sufficiently large audience of potential buyers to maximize market price for a product. This is because auctions are often limited to a select number of buyers with knowledge of the auction and located within a reasonable distance of the auction. Potential buyers for a given auction may further be limited to specific registered buyers determined by local, state, or federal rules, regulations or statutes defining what type of entity or agent can purchase a certain class of product. Thus, auctions may often have an overly limited buying audience to which items being auctioned may be sold. Such overly limited buying audiences may artificially suppress a true market price of a product, and the seller receives less for a product than the seller would receive if the buying audience could be expanded.

Systems and methods that can increase the size and diversity of a buying audience for the auctioning of any type of good or product, and especially for unique goods, would be beneficial to the seller of good or product in achieving a price that is closer to the true market value of the good or product.

### SUMMARY

Methods for marketing and selling auction items using systems are disclosed herein. In one embodiment a method includes the steps of providing a system for generating a customized auction website to facilitate access to an inventory of auction items, receiving a request from a subscriber of the system to generate a customized auction website to provide access to the inventory of auction items for a user of the customized auction website, and generating the customized auction website according to subscriber specified parameters. The method further includes the steps of receiving a bid request for an auction item from a user of the customized auction website and communicating a response to the bid request to the user via the customized auction website. The method can optionally include steps such as forwarding the bid request from the user to an auction house that is conducting the auction and/or receiving a response to the bid request from the auction house, where the response to the bid request indicates whether the bid request is a winning bid request. An auction house can supply items to the auction item inventory, a subscriber or multiple subscribers can supply items to the auction item inventory, or both an auction house and subscriber(s) can supply items to the auction item inventory. The method can also optionally include steps of a subscriber taking ownership of the auction item upon a user winning an auction item and subsequently the subscriber transferring ownership of the auction item to the user.

Another method includes the steps of providing a system for use by an auction house and a plurality of buyers and arranging the system so that a customer associated with one of the plurality of buyers can review an auction inventory and place a bid on an auction item without knowing the identity of the auction house. The method further includes the steps of receiving a bid placed by the customer for the auction item, forwarding the customer's bid to the auction house without the auction house knowing the identity of the customer, and receiving a response to the customer's bid from the auction house. The response to the customer's bid includes an indication of whether the customer's bid is a winning bid. The response to the customer's bid is forwarded to the customer. If the customer's bid is the winning bid, the buyer associated with the customer takes ownership of the auction item, and the buyer transfers ownership of the auction item from the buyer to the customer. The method can optionally be facilitated by websites that are customized for each of the plurality of buyers. One or more buyers can supply auction items to the inventory of auction items. When a buyer supplies an auction item to the inventory of auction items, customers of other buyers can view and bid on the auction item.

Another method includes the steps of an auction house providing customized websites to a plurality of buyers and each of the plurality of buyers providing access to the customized website to customers associated with the buyer. The method further includes the steps of receiving a bid on an auction item from a customer associated with one of the plurality of buyers and responding to the bid, where the response to the bid includes an indication of whether the bid is a winning bid. If the bid is the winning bid, ownership of the auction item is transferred to the buyer associated with the customer. Optionally, buyers can supply auction items to the auction. When a buyer supplies auction items to the auction, customers of other buyers can view and bid on the auction item. In one embodiment, the buyers collectively supply a substantial portion of the auction items.

Another method includes the steps of receiving auction data from a plurality of auction providers, and receiving a request from a subscriber to generate a customized auction website to display auction inventory. The method further includes the steps of generating a customized auction website according to subscriber specified parameters, and receiving a bid request for an auction item via the customized auction website. The request is then communicated to the subscriber.

### BRIEF DESCRIPTION OF THE DRAWINGS

In the accompanying drawings, structures are illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 illustrates an example system for marketing and selling auction items.

FIG. 2 is a flow chart illustrating an example method for marketing and selling auction items.

FIG. 3 illustrates an example user interface of an example system for marketing and selling auction items.

FIG. 4 illustrates an example user interface of an example system for marketing and selling auction items.

FIG. 5 illustrates an example user interface of an example system for marketing and selling auction items.

FIG. 6 illustrates an example user interface of an example system for marketing and selling auction items.

FIG. 7 illustrates an example user interface of an example system for marketing and selling auction items.

FIG. 8 illustrates an example “place an offer” button on a user interface of an example system for marketing and selling auction items.

FIG. 9 illustrates Google Analytics integrated on a user interface of an example system for marketing and selling auction items.

FIG. 10 illustrates an example user interface of an example system for marketing and selling auction items.

FIG. 11 illustrates an example user interface of an example system for marketing and selling auction items.

FIG. 12 illustrates an example user interface of an example system for marketing and selling auction items.

FIG. 13 illustrates an example user interface of an example system for marketing and selling auction items.

FIG. 14 illustrates an example user interface of an example system for marketing and selling auction items.

FIG. 15 illustrates an example user interface of an example system for marketing and selling auction items.

FIG. 16 illustrates an example user interface of an example system for marketing and selling auction items.

FIG. 17 illustrates an example user interface of an example system for marketing and selling auction items.

FIG. 18 illustrates an example user interface of an example system for marketing and selling auction items.

FIG. 19 illustrates an example user interface of an example system for marketing and selling auction items.

FIG. 20 illustrates an example user interface of an example system for marketing and selling auction items.

FIG. 21 illustrates an example user interface of an example system for marketing and selling auction items.

FIG. 22 illustrates an example user interface of an example system for marketing and selling auction items.

FIG. 23 illustrates an example user interface of an example system for marketing and selling auction items.

FIG. 24 is a flow chart illustrating an example method for marketing and selling auction items.

FIG. 25 is a block diagram of an example computing system for implementing an example system for marketing and selling auction items.

### DETAILED DESCRIPTION

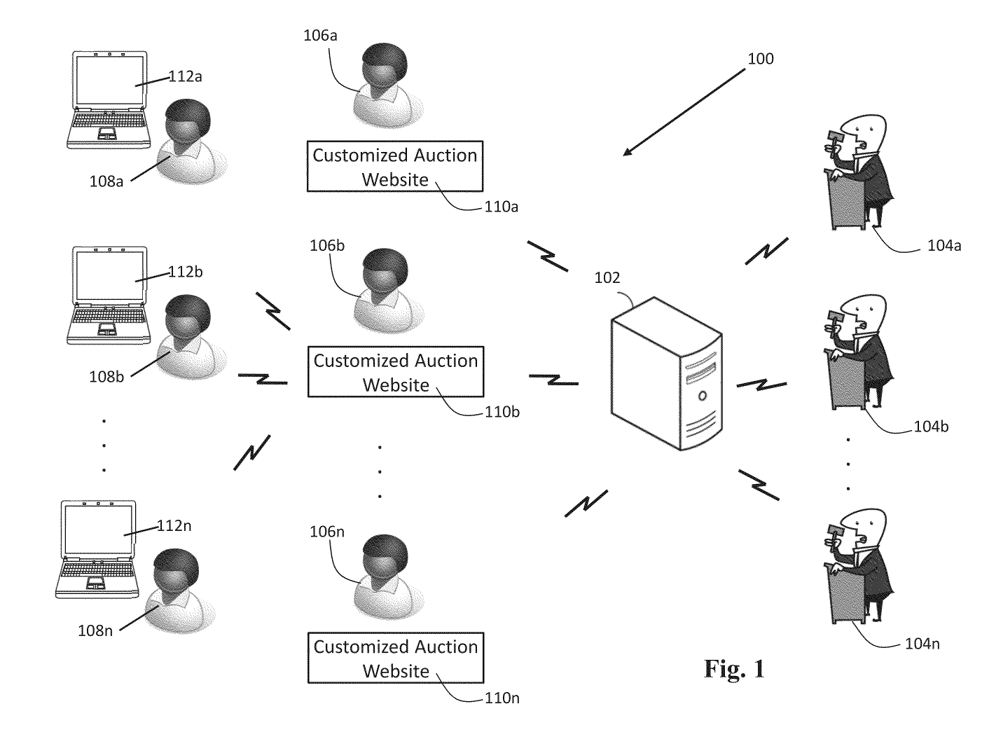

The systems and methods disclosed in this document are described in detail by way of examples and with reference to the figures. It will be appreciated that modifications to disclosed and described examples, arrangements, configurations, components, elements, systems, methods, etc. can be made and may be desired for a specific application. In this disclosure, any identification of specific techniques, arrangements, methods, etc. are either related to a specific example presented or are merely a general description of such a technique, arrangement, method, etc. Identifications of specific details or examples are not intended to be and should not be construed as mandatory or limiting unless specifically designated as such. Selected examples of systems and methods for marketing and selling auction items are hereinafter disclosed and described in detail with reference made to FIGS. 1-25.

This disclosure includes a number of definitions that are identified at the end of this detailed description. For this disclosure, the terms “computing device,” “computer readable media,” “logic,” and “software” will include the definitions hereinafter provided in this detailed description.

Traditional auctions are typically conducted by “auction houses” that sell products to interested buyers. An auction house may own the products directly or provide a service that creates a market place for the owners of products and potential buyers of those products to facilitate a sale of the products. As used herein, the term “buyer” refers to traditional buyers of goods and products from auction houses. Many such buyers purchase products to resell to their customers, which are customers or end users of the products. As used herein, the terms “customer” and “end user” both refer to an individual or entity that purchases a product to own and use. When a buyer purchases a product through an auction, the goal is typically to resells the product to a customer or end user at a higher price and keeps the difference as profit. As previously described herein, traditional auction houses often fail to maximize the audience for an auction because of logistical and regulatory issues.

Buyers traditionally purchase products from multiple auction houses. That is, buyers attend periodic auctions at a variety of auction houses to purchase various products at various price points to create an inventory of products to sell to their customers and end users. Such traditional methods can be time consuming and inefficient for the buyer. In addition, the buyer often takes ownership and/or possession of products purchased through an auction. This includes transporting and storing products purchased until the products can be sold to customers and end users.

Disclosed and described herein are systems and methods that expand the audience for an auction by providing mechanisms for a buyer to expose the buyer's end users to products being sold at auction in real time. Furthermore, the systems and methods described herein can provide for multiple buyers to participate such that end users for the multiple buyers are exposed to the products being sold in real time. The products being offered for sale can be owned or provided by an auction house conducting the auction, by a plurality of auction houses, by one or more buyers, or by a combination of auction house(s) and/or buyer(s).

As will be appreciated upon reading and understanding this disclosure, an auction house that traditionally conducts auctions for goods that it provides (either because the auction house owns the goods or the goods have been consigned or provided to the auction house for the purposes of auctioning the goods), can benefit by the methods and systems disclosed herein by expanding the number or buyers and customers that can participate in the auction. As will be appreciated, if a single or multiple traditional buyers can provide information about a product for sale at an auction to all their collective customers (i.e., end users), the audience for the auction can be greatly increased and, thus, the sale price of a product is likely to be higher and the duration of time it takes to sell a product will likely be shorter.

Buyers can also benefit from the methods and systems disclosed herein. The methods and systems provide for buyers that own goods to provide those goods to the inventory of items to be auctioned. Traditionally, buyers try and sell goods to customers of the buyer. When a buyer provides goods to the auction inventory, those provided goods can be exposed to customers of all buyers participating in the auction, thus expanding the audience for the buyer's goods.

Furthermore, the systems and methods described herein can provide for the transactional sale of a product from the auction house to the buyer and the subsequent transactional resale of that product from the buyer to the end user to be accomplished either contemporaneously or in rapid succession. Thus, eliminating the need for the buyer to transport and store the product while the buyer searches for an end user to purchase the product. Such an arrangement provides for an overall transaction that is economically and logistically efficient for the buyer and the end user.

FIG. 1 illustrates an exemplary system 100 for marketing and selling items through an online auction. For explanatory purposes only, some of the examples of systems described herein will refer to transportation vehicles such as pre-owned automobiles as the products sold through online auctions. It will be understood that, although the example systems and methods described herein may refer to pre-owned automobiles as sold through online auctions, the example systems and methods can similarly be implemented for use with any goods, products, or services being sold through an auction. For example, systems and methods disclosed and described herein can be applicable to auctions for real estate, watercrafts, art, antiques, industrial equipment, motorcycles, automotive parts, and the like.

As noted above, pre-owned automobiles can be sold through auctions. Sellers can benefit from selling pre-owned automobiles through an online auction. Although, automobiles can be categorized by make, model, and year, the value of a pre-owned automobile can depend on a number of additional factors such as mechanical condition, aesthetic appearance, number of miles driven, accident history, factory installed options, aftermarket options, owner history, geographical location, and so on. Selling pre-owned automobiles through online auctions can lead to fast sales at a fair and true market price. This may be particularly true when the pre-owned automobiles are “salvaged” vehicles. A salvaged vehicle is a vehicle that has been involved in an accident or subject to sever weather, and an insurance company has determined that the vehicle is a “total loss.” In such a situation, the insurance company compensates the vehicle owner for the loss of the vehicle and takes possession of the salvaged vehicle. In such a situation, the insurance company is left with a vehicle that has value, but it may be difficult to realize the full value unless the salvaged vehicle is offered for sale to a large and diverse audience of buyers or customers.

A traditional audience of buyers for a salvaged vehicle may be further restricted by local, state, and/or federal rules, regulations or statutes that may restrict the purchase of salvaged vehicles to certain authorized brokers and dealers that hold proper registrations and/or credentials in a given jurisdiction. Such registered or accredited buyers often serve as a “middleman” to facilitate the transfer of salvaged vehicles from the insurance company to an end user. Systems and methods are described herein that overcome restrictions that may be placed on traditional auctions by providing sellers of goods and products access to a large and diverse audience of end users of the product.

In particular, systems and methods described herein enable an auction house to market items to a larger customer base. At the same time, systems and methods described herein provide a streamlined inventory management and payment solution that enables an auto dealer to efficiently market and sell autos from a variety of auction houses to the auto dealer's customers, alongside the dealer's own inventory, without having to take on the risk of buying excess inventory.

Referring again to the exemplary system 100 illustrated in FIG. 1, the system 100 enables traditional buyers of items through auction houses to market the auction house's goods and products further downstream to the buyers' customers (i.e., the end user of the products). In one embodiment, the system 100 provides for such downstream marketing without the need to reveal the source of the products (i.e., identity of the auction house) to the end user or revealing the identity of the end user to the auction house. Such an arrangement allows the buyer to control both transaction. The end user can view and bid on the product being auctioned. Upon an end user winning the auction, the buyer can purchase the product from the auction house and immediately resells the product to an end user. The buyer can benefit from shielding the identity of the auction house from the end user and shielding the identity of the end user from the auction house. Such an arrangement allows the buyer to control each sale without jeopardizing future sales by providing information that the auction house can use to contact end users directly or that the end user can use to contact the auction house directly.

System 100 includes an auction server 102 configured to receive auction data from one or more auction houses 104a, 104b, and 104n (herein after referred to as “auction provider 104”). The auction data includes information about the auction as well as the items being auctioned. For example the auction data can include names and descriptions of items being sold, photos of items, condition of items, usage history or other suitable item reports, starting bids, duration of auction, location of auction, and other suitable information for a consumer to make a decision about purchasing the item being auctioned. The system 100 enables the auction providers 104 to upload and continually update auction data to the auction server 102 so that the auction server 102 includes generally accurate auction data.

The auction data of the various auction providers 104 can be formatted and presented differently. For example, the file format used for communicating the auction data by the auction providers 104 can differ, the naming convention for data fields can differ, or the naming convention of the items can differ. Thus, in one example, auction server 102 is configured to curate the auction data received from auction providers 104. In other words, auction server 102 is configured to convert the auction data received in various formats into one common format.

In addition, auction server 102 can be configured to receive auction data via various means. For example, auction server 102 can be configured to receive auction data electronically over a data connection such as, for example, the internet. In one example, auction data can be received in a continuous data feed (i.e., XML) or a web service. The auction server 102 can also be configured to receive auction data electronically from digital media such as a portable storage device. The auction data can be configured in a variety of formats such as in a database file, a spreadsheet, text document, and so on. Auction server 102 can also be configured to receive auction data via manual input by a user using a keyboard, a mouse, a touchscreen, or other similar input means.

In one example, the auction server 102 is configured to receive auction data in real time. In other words, the auction server 102 is configured to continuously receive updated auction data as auction items as that auction data changes. For example, when an auction item is bid on, the current bid price is sent to the auction server 102 so that all potential buyers are aware of the current bid. The current bid is continuously updated as each bid is accepted. Similarly, when a bid becomes a winning bid, i.e., the bid that results in a sale of the auction item, the auction data is updated to list the auction item as sold and no longer available for bidding. In another example, the auction server 102 is configured to receive auction data prior to an auction taking place without receiving any additional updated auction data until after the auction is completed. In one example, auction server 102 is configured to receive a combination of both real time and non-real time auction data.

The system 100 is configured so that one or more buyers 106a, 106b, and 106n (hereinafter buyers can also be referred to as subscriber(s) 106) can subscribe to a service that allows the buyer 106 to access the auction data on the auction server 102 and expose the auction data to the subscriber's 106 customers 108a, 108b, and 108c (hereinafter customers can be referred to as end users 108). A subscriber 106 and end users 108 can be associated in a number of ways. For example, an end user 108 can be a frequent customer of the subscriber 106 or could be a first time prospective customer that comes to the subscriber 106 to shop for the item the end user 108 wants to purchase. In any event, an end user 108 and subscriber 106 are associated when the end user 108 uses the subscriber's 106 website 110 to view and/or bid on auction items. It will be understood that the nomenclature used for “auction providers 104a, 104b, and 104n” (and subscribers 106, end users 108, customized auction websites 110, and computing devices 112) means that there can be without limitation any number of auction providers 104 associated with the system 100.

Auction server 102 is further configured to enable a subscriber 106 to reformat and arrange the auction data so as to customize how the auctioned products are marketed to the subscriber's 106 end users 108. In one example, a subscriber 106 can be an auto dealer that may or may not be registered with an automobile auction provider 104. In particular, the system 100 provides a subscriber 106 with the ability to create a customized auction website 110a, 110b, and 110n to display auction inventory to the subscriber's end users 108, where the end users 108 can access the auction inventory via a computing device 112a. 112b, and 112n such a personal computer, a smartphone, a tablet, and so on. FIG. 1 illustrates multiple subscribers 106a, 106b, and 106n, each with a dedicated customized websites 110a, 110b, 110n. However, FIG. 1 only illustrates one set of end users 108a, 108b, 108n accessing the customized website 110b of one subscriber 106b. It will be understood that each subscriber 106a, 106b, and 106n has multiple end users 108a, 108b, and 108n and the illustration of FIG. 1 is for convenience only. For example, subscriber 106a can have dozens or hundreds of end users 108 that access its customized website 110a to view items, bid on items, or otherwise participate in auctions.

The system 100 provides a number of benefits to all parties. The system 100 enables a subscriber 106 to offer an expanded virtual inventory to end users 108 without purchasing or consigning the inventory or requiring physical access to the inventory. At the same time, auction providers 104 gain additional exposure to potential consumers that may otherwise not have had access to auction provider's 104 inventory. Furthermore, the end user 108 is presented with an expanded inventory from which to make purchasing decisions.

The system 100 can be arranged to allow a subscriber 106 to choose between various levels of service, which can be priced accordingly. In one example, the system 100 can be configured to provide a subscriber 106 with varying functionality for the customized auction website 110 used by the subscriber 106. The auction server 102 can be configured to enable a subscriber 106 to choose between one or more tiers for a customized website 110. For example, a higher tier website can offer additional features to the subscriber 106 as compared to a lower tier website, where an administrator of the auction server 102 can charge more money for a higher tier website. In one example, a higher tier website option can allow for more advanced customization of a website or support a greater number of users while a lower tier website can require a subscriber to choose from a standard website design or may only support a limited number of users. In another example, when a subscriber 106 has its own website, the system 100 can provide a syndicated solution. If the subscriber 106 would prefer to utilize the functionality of the system 100 on its existing website, a widget can be placed on the subscriber's 106 existing website to provide a portion of or all of the functionality that can be implemented via a customized auction website 110.

Auction server 102 can be configure to hide the identity of auction providers 104 while enabling a subscriber 106 to present auction items provided by those auction providers 104 to end users 108. In one embodiment, a subscriber's 106 website 110 is designed to only reference and/or provide information about the subscriber 106. The website 110 can further give the appearance that any item up for auction is controlled by the subscriber 106. That is to say that the subscriber's 106 website 110 can use the subscriber's name, address, business information, logos, trademarks, etc. to sufficiently brand the website 110 so that it is associated only with the subscriber 106 and no other person or entity. Thus, when viewing and using the website 110, an end user 108 is only aware of the subscriber 106. Such an arrangement can prevent the end user 108 from circumventing the subscriber 106 and contacting an auction provider 104 directly to make a bid on an item after identifying the item of interest via the subscriber's 106 customized auction website 110.

The system 100 can be configured to enable the end user 108 to place a bid on an auction item via the subscriber's 106 website 110. The end user's 108 bid can be passed onto the auction server 102 to facilitate the purchase of an item by the end user 108, provided the end user's 108 bid is the highest (i.e., the winning bid). As noted above, the transaction between an end user 108 and the subscriber 106 can be shielded from the auction provider 104, and the transaction between the subscriber 106 and auction provider 104 can be shielding from the end user 108. This is to say, if an end user 108 is ultimately successful in purchasing an auction item by offering the highest bid, the end user 108 does not know the amount of money the subscriber 106 pays the auction provider 104 for the auction item, and the auction provider 104 does not know the amount of money the end user 108 pays to the subscriber 106 for the auction item. In another embodiment, the system 100 can be configured so that the identities and the actions of the auction provider 104, subscriber 106, and/or end user 108 are transparent to all parties of the transaction.

The system 100 can be further configured to enable a subscriber 106 to include a profit margin in the price displayed to an end user 108. For example, a subscriber 106 can choose to automatically include a specified percentage mark-up in the price displayed to the end user 108. Thus, if an auction provider 104 prices an initial bid for an auction item at $5,000, for example, system 100 can automatically add a 10% markup for display to a first subscriber's 106 end users 108 (i.e., a price of $5,500 is displayed to those end users 108). If a second subscriber 106 chooses a 20% markup, that same auction item subject to the $5,000 initial bid will be displayed with an initial bid of $6,000 for the second subscribers 106 end users 108. It will be appreciated that due to the varying markups selected by subscribers 106, an end user 108 of the second subscriber 106 can actually place a higher bid than an end user 108 of the first subscriber 106, and the end user 108 of the first subscriber 106 can still win the auction item.

Additionally, system 100 can be further configured to include auction fees into an auction item price. For example, a subscriber 106 may be required to pay an auction provider 104 a buyers fee, an internet bid fee, a documentation fee, and so on. The fees may be broken down and displayed individually alongside an auction item price, along with a total price. Or, the fees may be hidden from an end user 108 and automatically added to a displayed auction item price.

The system 100 can be arranged to allow the subscriber 106 to provide methods for end user 108 to automate payment for winning bids or fees. In one embodiment, the system provides for the subscriber 106 to post payment instructions to the end user 108. For example, a portal can be provided on a customized website 110 via a link, button or other means by which end user can submit payments. An example of one such portal is commercially known as PayPal. The subscriber 106 can define rules that require the end user 108 to provide a deposit when placing a bid on an item and/or when the end user's 108 bid becomes the winning bid for the auction item. Such required deposits can be submitted via the payment portal. It will be understood that providing a payment portal can result in a system 100 that efficiently and quickly processes payments for deposits, fees, and purchases. An end user 108 can pre-qualify or register for using a payment portal.

It will be understood that the system 100 can be arranged to handle payments for auction items in a number of ways. For example, the system can be arranged so that full payment is made from the end user 108 to the subscriber 106, and the subscriber 106 forwards the appropriate portion of the payment to the auction provider 104. In another example, the system can be arranged so that upon payment by the end user 108 an appropriate portion of the payment is sent to the subscriber 106 and an appropriate portion is sent to the auction provider 104. In yet another example, when an end user 108 of one subscriber 106a wins an auction for an item owned by another subscriber 106b, the system 100 can be arranged so that payment is divided appropriately between the first subscriber 106a, the second subscriber 106b, and the auction provider 104. The system 100 can also be arranged so that the first subscriber 106a receives full payment, and the first subscriber 106a forwards appropriate payment to the second subscriber 106b and the auction provider 104.

The customized website 110 can include a calculation feature that can take subscriber 106 and auction provider 104 rules into consideration to calculate purchase price, deposits, and other charges owned by the end user 108. For example, a calculation feature can provide for the subscriber 106 to specify an exact deposit (flat fee or percentage) required to purchase an item. Such an amount can be published on the customized website 110, allowing end users 108 to know the exact deposit amount required. Such amount can be dynamically calculated by the system 100 for the end user 108 when the end user 108 submits a bid.

A subscriber 106 can control who has access to its customized website 110 by applying additional fees such as membership fees to end users 108. Such membership fees can also be handled through the payment portal. If a subscriber 106 elects to charge membership fees, the system 100 can notify the end user 108 upon registration with the customized website 110, and the end user 108 can be provided with instructions on how to pay such membership fees via a link to a payment portal. Upon the registration of a new end user 108, the subscriber 106 can be notified of the new registrant, and the subscriber 106 can manage the access to the customized website 110 provided to the new end user 108. If a specific membership term is selected, such as one month or one year, the system 100 can allow the end user 108 access to the customized website 110 until such term expires. Access to the customized website 110 can be automatically revoked by the system 100 upon expiration of the membership term. In another example, an end user's 108 membership can be renewed automatically, with or without notice to the end user 108, using information provided by the end user 108 at the time of registration or at any time the end user 108 used the payment portal.

It should be understood that, although a single subscriber 106 and a single customized auction website 110 are generally described and illustrated herein, auction server 102 can be configured to enable multiple subscriber 106a, 106b, 106n to create customized websites 110a, 110b, and 110n to present auction inventory of multiple auction providers 104a, 104b, and 104n to multiple end users 108a, 108b, 108n. Accordingly, end users 108 may overlap, or access the same auction inventory via two different customized auction websites 110. If such access occurs via multiple customized auction websites 110, the end user 108 will be associated with the subscriber 106 whose customized website 110 is used to place a bid on an auction item. In one example, auction server 102 is configured to prevent an end user 108 from bidding on auction inventory via a second subscriber's 106 customized website 110 after the end user 108 first accesses the same auction inventory via a first subscriber's 106 customized website 110.

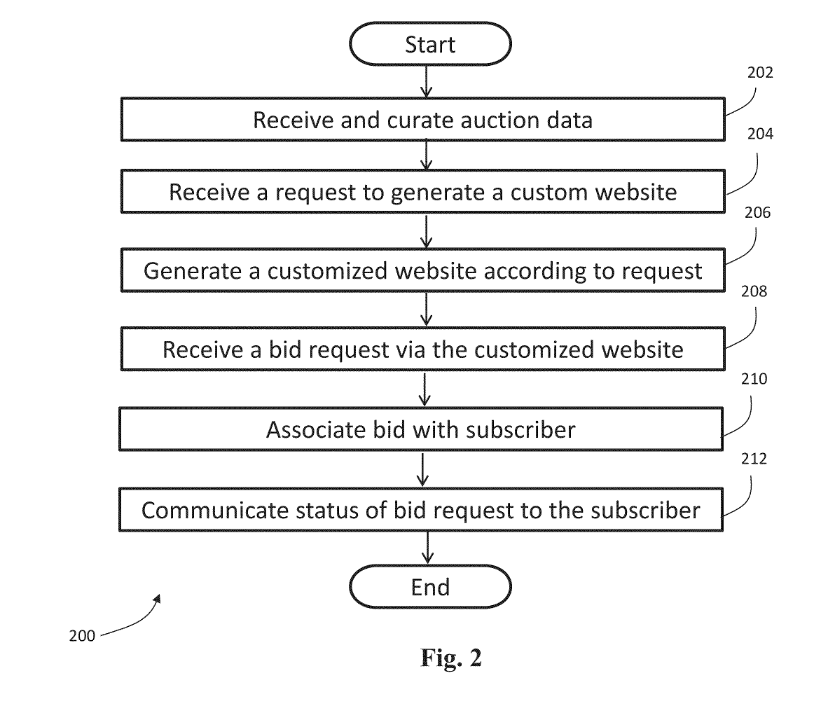

FIG. 2 is a flow chart illustrating an exemplar method 200 for marketing and selling auction items. At step 202, an auction server 102 receives and curates auction data from one or more auction providers 104. At step 204, the auction server 102 receives a request from a subscriber 106 to create a customized auction website 110. At step 206, the auction server 102 generates a customized auction website 110, according to subscriber 106 specified parameters, for virtually marketing the auction inventory of the auction providers 104 to end users 108. At step 208, the customized website 110 receives a bid request from an end user 108 to purchase an auction item. The bid can be forwarded from the customized website 110 to the auction server 102. At step 210, the bid is associated with the subscriber 106. The bid can be associated with the subscriber 106 by submitting the bid to the auction server 102 with information that specifically identifies the subscriber 106. Such a bid could be submitted automatically by customized website 110, if such option is selected by the subscriber 106. Alternately, subscriber 106 can be notified of a bid submission by user 108 via email or other suitable means. The subscriber 106 can also submit such a bid manually to the auction server 102 via a redirect link on the customized website's 110 back office functionality after the subscriber 106 has evaluated the end user's 108 bid, pre-qualifications, restrictions, etc.

At step 212, the auction server 102 communicates the status of the bid request to the subscriber 106. That is to say, the auction server 102 communicates to the subscriber 106 whether the bid was successful or unsuccessful. The subscriber 106 can then communicate this status of the bid to the end user 108 via the customized auction website 110.

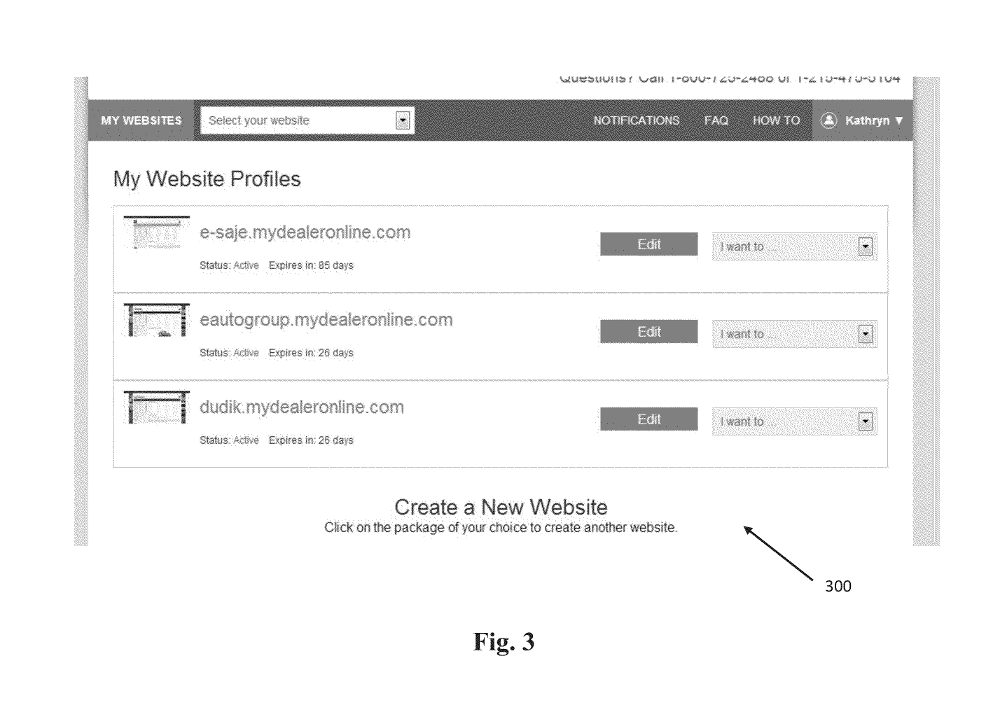

FIG. 3 is an example landing page user interface 300 of a backend portal provided by auction server 102 to enable a subscriber 106 to create and manage customized auction websites 110. In particular the subscriber 106 can create and customize an auction website 110 for use by its end user 108. The subscriber 106 can also subsequently make changes to an already existing customized auction website 110 as the subscribers 106 and its end user's 108 needs change over time.

A customized auction website 110, as referred to herein, can include a standalone website for displaying auction item inventory of one or more auction providers 104 that includes some reference to the subscriber 106 for whom the auction website 110 is customized. It will be understood that different subscribers 106 can choose different levels of customization. For example, one subscriber 106 can fully customize an auction website 110 so that the website's 110 “look and feel” and layout are arranged so that the website 110 conforms with the subscriber's 106 other commercial websites. Another subscriber 106 can choose basic customization where only the subscriber's 106 name is added to a generic website provided by the system 100. In another example, a customized auction website can also include a syndication widget or other application that can integrated into a subscriber's already existing website. For example, in one embodiment, a subscriber is an auto dealer that has an existing website that displays the dealer's inventory on the dealer's lot. The backend portal provided by auction server 102 can enable the auto dealer to insert and integrate the auction items offered by one or more auction providers 104 into the auto dealer's already existing inventory that is routinely displayed on the auto dealer's website. In such an arrangement, the inventory of one or more auction providers 104 can be shown along with the inventory owned by the auto dealer so that the end user 108 does not distinguish between the inventory of the auto dealer and the inventory of the auction providers 104. This is to say that from the end users 108 point of view, all the inventory presented on the auto dealer's website appears to be controlled by the auto dealer.

The backend portal provided by auction server 102 can also enables the auto dealer to insert and integrate the dealer's own inventory into a custom auction website. The auto dealer can choose to feature its own inventory, for example, on the custom auction website. In addition, the backend portal provided by auction server 102 can also enables the auto dealer to propagate or make available its own inventory to other subscribers 106 of the system 100. Thus, in addition to the auto dealer being able to offer an extended inventory to its customers, the auto dealer is also able to gain extra exposure for its own inventory by making it available to end users of other subscribers 106 of the system 100.

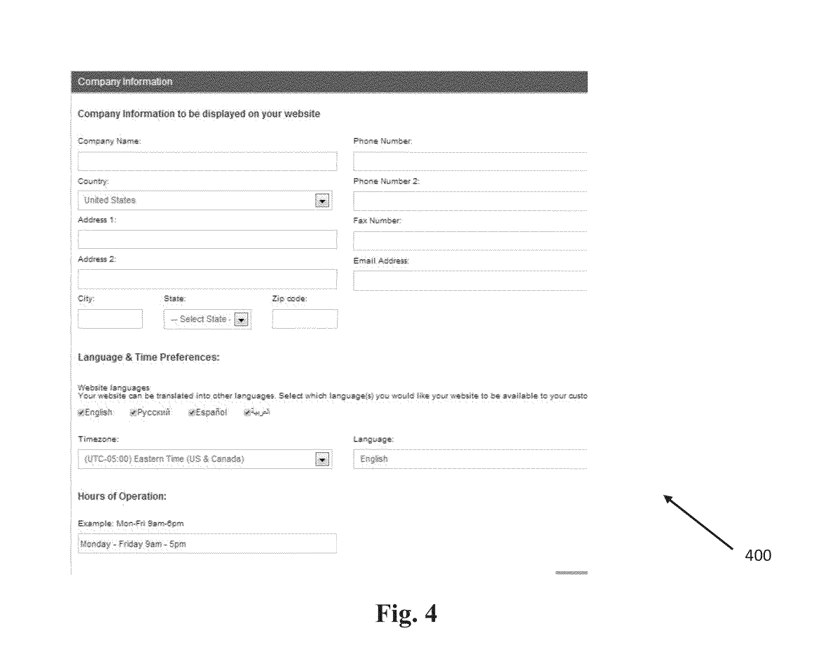

Upon a subscriber 106 selecting an option to create a new website via the backend portal, the auction server 102 can be arranged to present a series of user interface screens for enabling a subscriber 106 to create and customize a new website. FIG. 4 is an example company information user interface 400 that can enable a subscriber 106 to provide information about the company to be displayed on the customized website 110. Company information can include, for example, a name and location of an auto dealership, the hours of operation, and so on. It should be understood that the example user interface screens described herein are not limiting and that the user interface screens as described and shown can be modified and enhanced to accommodate data entry of other suitable information.

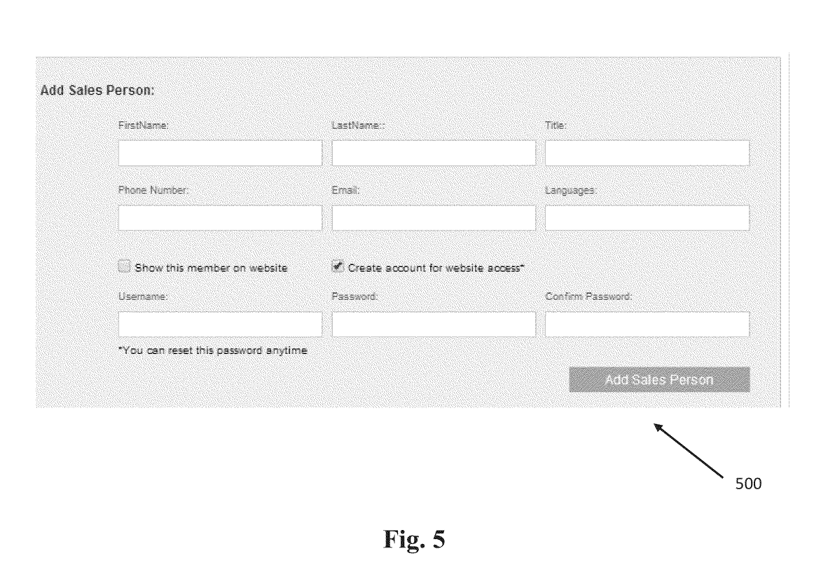

FIG. 5 is an example sales person user information interface 500 for enabling the subscriber 106 to add and modify names and contact information of sales people to be listed on the customized auction website 110. The sales person user information interface 500 can also be used to assign a username and password credentials to a sales person in order to grant the sale person administrative access to the customized auction website 110.

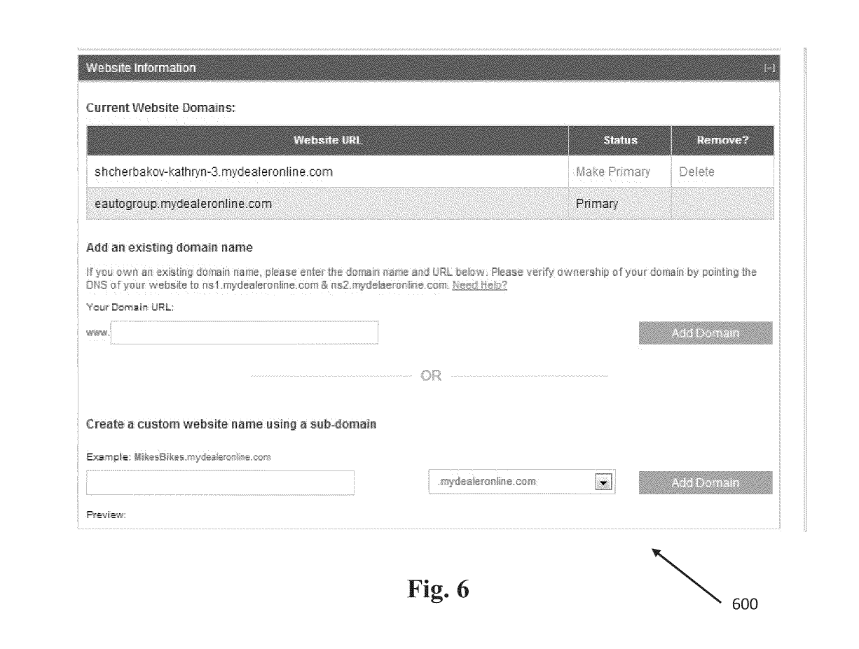

FIG. 6 is an example website information interface 600 for enabling the subscriber 106 to define a URL for accessing the custom auction website 110. Website information interface 600 enables the subscriber 106 to associate an existing domain name with the custom auction website. Alternatively, the subscriber 106 can opt to allow auction server 102 to auto-generate a new sub-domain name of a domain already hosted by auction server 102. For example, auction server 102 can host a domain called MyDealerOnline.com. Accordingly, a subscriber 106 can select a subdomain name, such as JonesAutos, and in turn be assigned a subdomain of JonesAutos.MyDealerOnline.com to associate with the respective custom auction website 110.

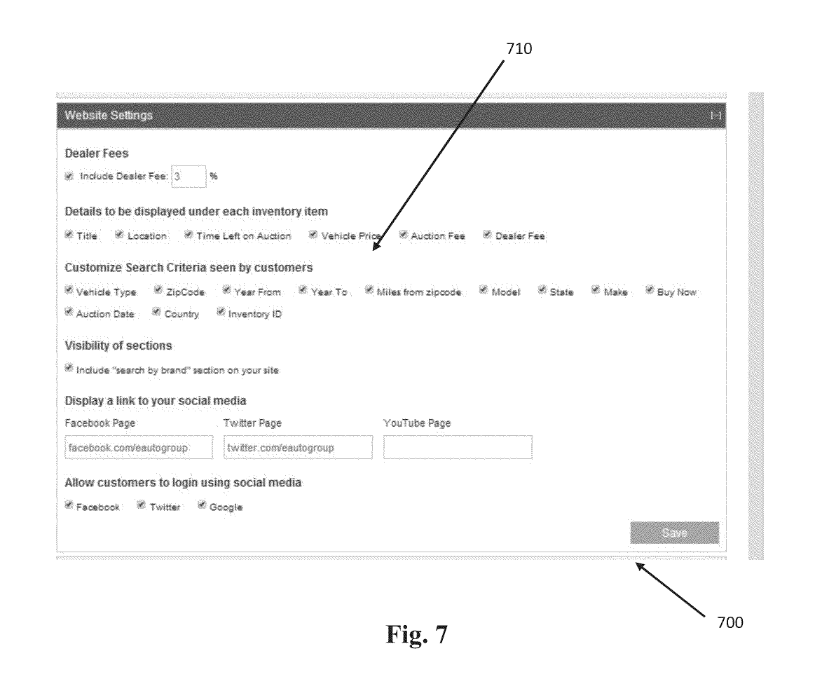

FIG. 7 is an example website settings interface 700 for enabling the subscriber 106 to define the settings for the custom auction website 110. The web settings interface 700 can enable any number of subscriber 106 defined settings. For example, website settings interface 700 can enable the subscriber 106 to select whether to include a commission fee or markup in the displayed auction price and to specify the amount of the commission fee. For example, the subscriber 106 can decide to include a 3% commission fee on an auction item transaction. Alternatively, the subscriber 106 can decide to apply a fixed commission of $1000 for each auction item transaction regardless of actual purchase price. The custom auction website 110 or the auction server 102 can be configured to markup the price of an item by the commission fee relative to the price of the item as indicated by the auction data received from the auction provider 104. The marked up price can then be displayed on the custom auction website 110 for the to end users 108 to view. The commission fee can represent the profit that the subscriber 106 makes on transactions facilitated by the system 100.

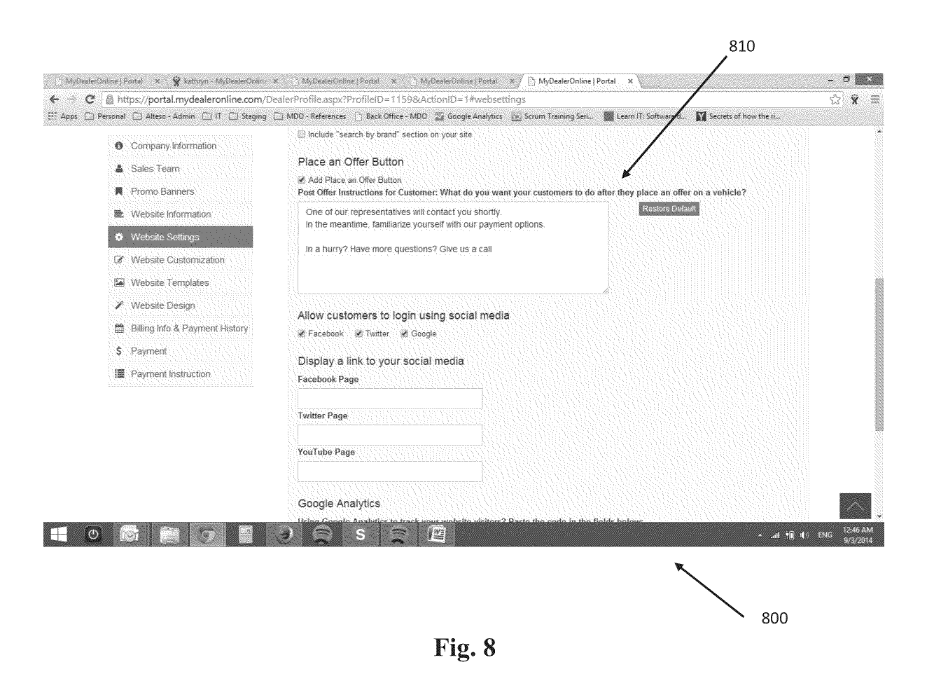

FIG. 8 illustrates a further example of a website setting interface 800 that provides for the subscriber 106 to customize the website 110. The subscriber 106 can enable bidding for end users 108 via a portal on a customized auction website 110. In the embodiment illustrated in FIG. 8, the website setting interface 800 includes functionality 810 for the subscriber 106 to include a “Place an Offer” button or link on the customized website 110.

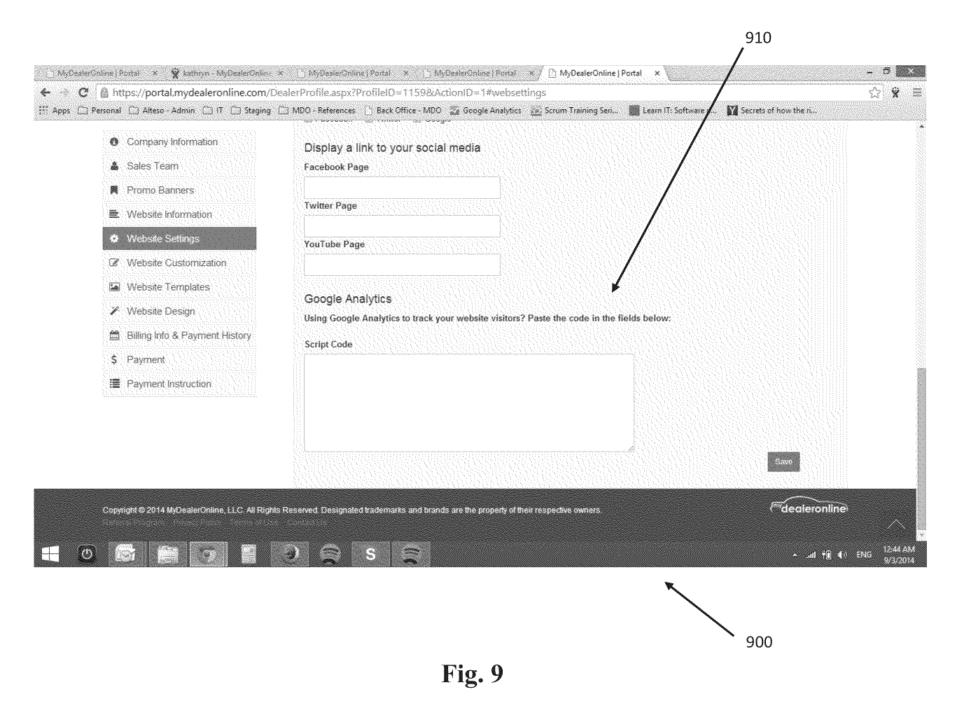

In addition, the customized auction website 110 can include analytic functionality to gather information on visitors to the customized auction website 110 and reporting such information to the subscriber 106. Such analytical functionality can also track and report specific page visits, views of specific inventory items, duration of views per page and inventory item, and other relevant data and information. The system 100 can include custom designed analytics functionality. For example, analytics functionality can be customized to subscribers. Some subscribers might be most interested in number of visits to their customized auction websites. Other subscribers might be most interested in the number of bids placed and on what type of vehicles the bids are placed. It will be understood, the analytics functionality can be designed to accommodate a number of business models, as well as be customized to any subscriber. As illustrated in FIG. 9, a website setting interface 900 can include functionality 910 the customize the auction website 110 to include integration with Google Analytics.

In addition, website settings interfaces 700, 800, or 900 can also enable the subscriber 106 to specify what search criteria are made available to the end user 108. In one example, website settings interface 700 provides functionality 710 that enables a subscriber to define a subset of auction items that can be made available to the end user 108. In one example, a subscriber 106 can create a customized auction website 110 that specializes in a particular make of automobile, such as Acura. In such an arrangement, end users 108 would only be able to search and find Acura automobile that are being auctioned. In such an example, a subscriber 106 that is an auto dealer that carries the Acura line of vehicles may want to limit all vehicles presented to its end users 108 via the auto dealer's website to only be Acura vehicles. Accordingly, subscriber 106 defines a filter, via website settings interface 700, to exclude all other automobile brands from being displayed to end user 108. In another example, the subscriber 106 can define search criteria based on many factors such as price, condition, year, type of vehicle (i.e., sedan, sports utility vehicle, truck), age, and many more criteria. It will be understood that website settings interface 700 also enables a subscriber to define other settings such as visibility of different sections and search options, social media links, and so on.

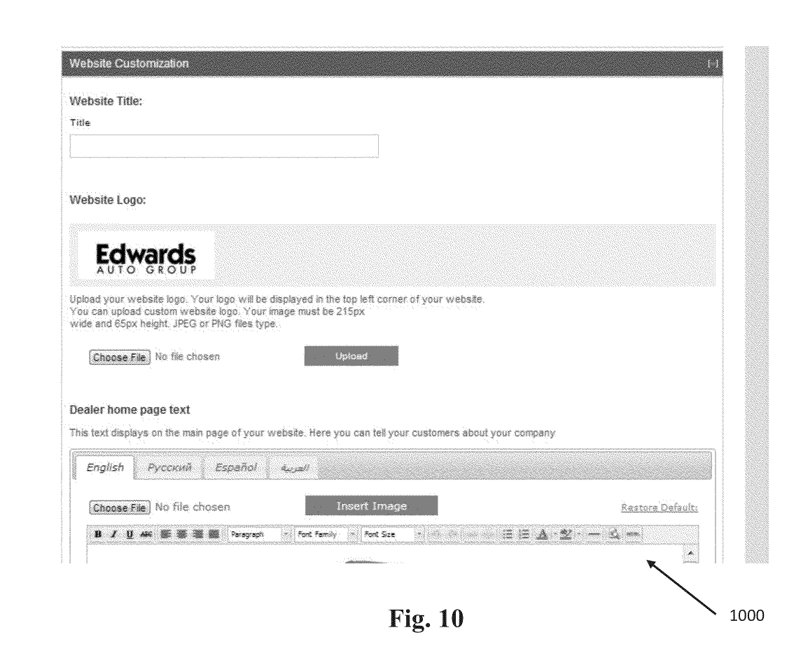

FIG. 10 is an example website customization interface 1000 for enabling the subscriber 106 to define the overall aesthetic look of a customized auction website 110. In particular, the website customization interface 1000 enables a subscriber 106 to define the title, logo, and text to be displayed on the custom auction website 110. It will be understood that such functionality can provide for the subscriber 106 to configure the customized auction website 110 so that the subscriber's 106 end users 108 will recognizable the website 110 as being associated with the subscriber 106.

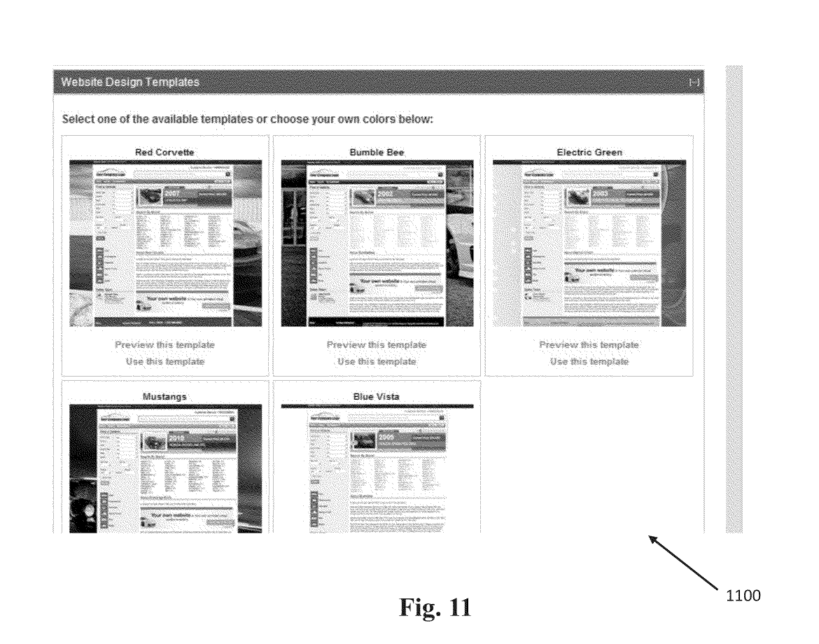

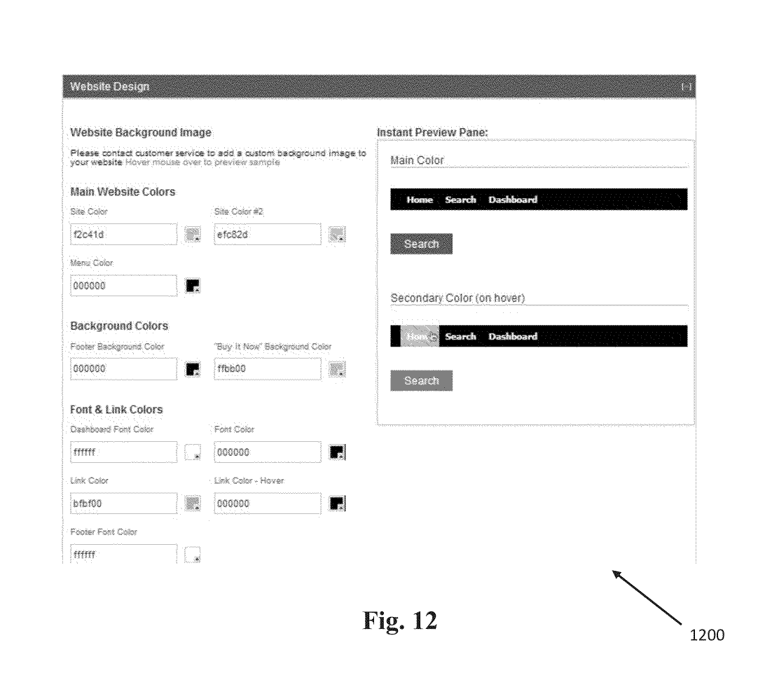

FIG. 11 is an example website design template interface 1100 for enabling the subscriber 106 to select a predefined template for the customized auction website 110. The template can include predefined color schemes, text and graphic layout, and so on. Alternatively, the website design interface 1200 illustrated in FIG. 12 enables a subscriber 106 to define a custom color scheme. For example, website design interface 1200 enables a subscriber 106 to select a website background image, the main website color, a background color, fonts and link colors, and so on.

Alternatively, a subscriber 106 can choose to use a generic website supported by the auction server 102. The generic website can be used by many subscribers 106. Each subscriber 106 can provide a unique username to the subscriber's 106 end users 108. For example, the unique username can be the subscriber's telephone number or company name. An entry field on the generic website would allow for end users 108 to enter the unique username and be forwarded to a webpage that is arranged to support a specific subscriber's 106 implementation on the system 100. The webpage would be arranged to display the subscriber's 106 name and contact information and display auctioned items based on preferences chosen by the subscriber 106. Use of a generic website by a subscriber 106 will be considered a customized auction website 110 for the purposes of this disclosure.

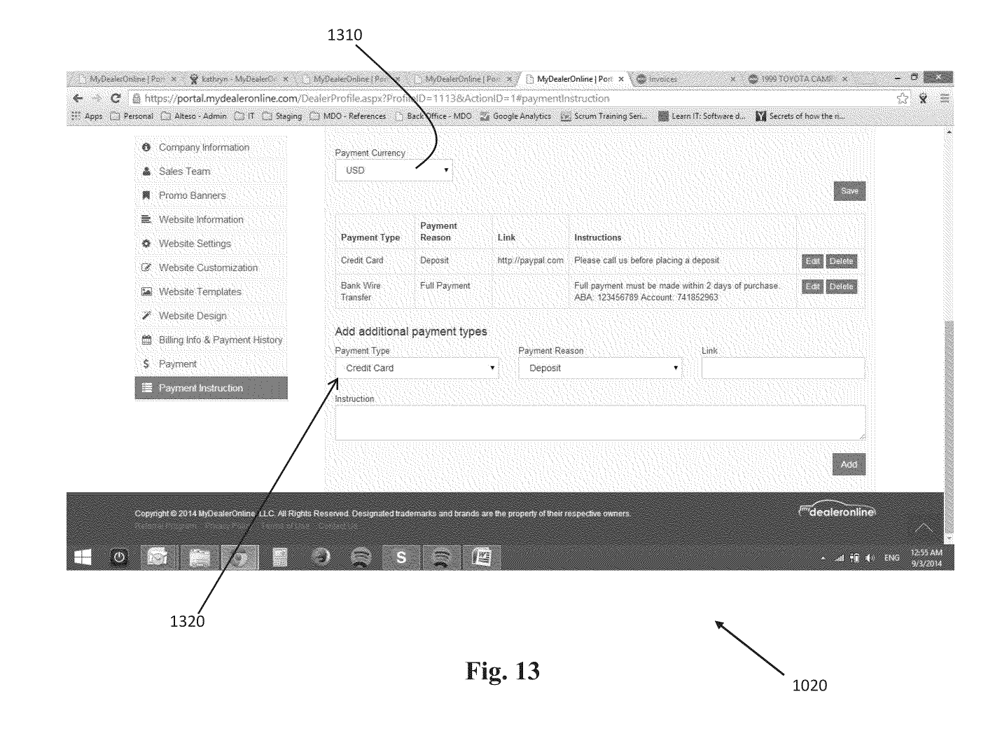

FIG. 13 illustrates an example of a payment settings interface 1300 that enables the subscriber 106 to define and set various parameters for payment methods to be offered to the end users 108. For example, the payment setting interface 1300 can include a drop down menu 1310 that allows for the subscriber 106 to select the currency or currencies in which payments will be accepted from end users 108. In one example, a subscriber 106 can set the acceptable currency to only U.S. dollars. In another example, the subscriber 106 can set the acceptable currency so that multiple currencies such as U.S. dollars and Canadian dollars are acceptable currencies of payment. The payment settings interface 1300 can include fields 1320 for selecting payment types. As is illustrated in FIG. 13, various payment types can be assigned for various payment reasons. For example, a credit card payment can be selected for paying a deposit, while a bank wire transfer can be selected for full payment for an item. Such selections will result in an end user 108 being offered the option of paying for a deposit using a credit card and being offered the option of making full payment with a bank wire transfer. The subscriber 106 can also provide internet links specific to certain payment types and instructions to guide the end user 108 in using the various payment methods.

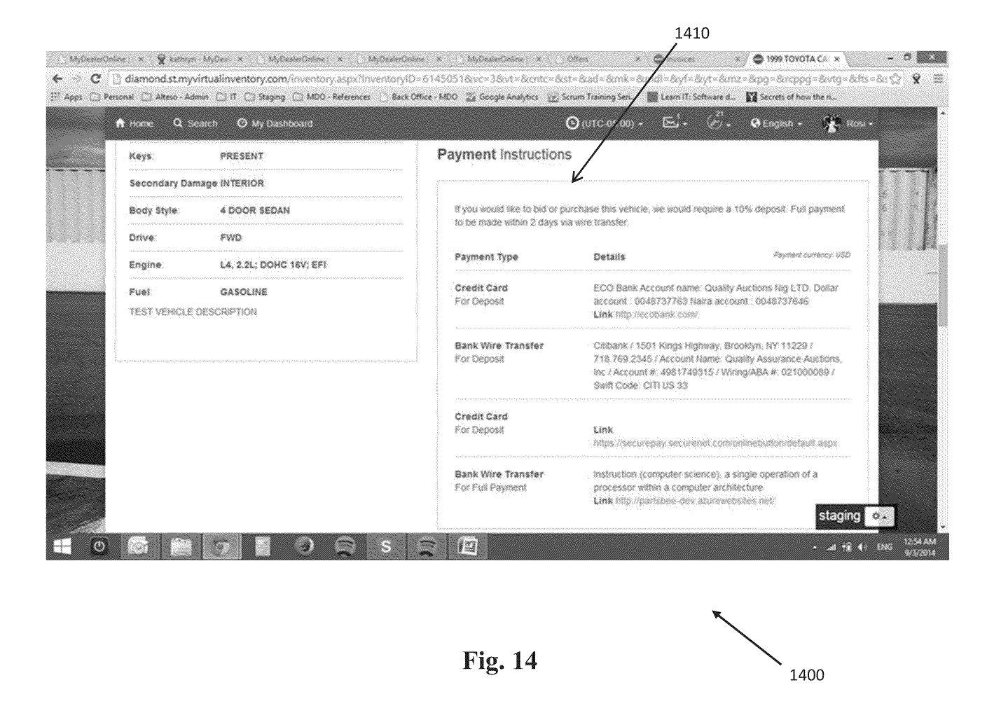

FIG. 14 illustrates an example of a payment instruction webpage 1400 of a customized auction website. It will be understood that the choices made by the subscriber 106 on the payment settings interface 1300 can determine the arrangement of the payment instruction webpage 1400. For instance, a subscriber's 106 selection in the payment settings interface 1300 of credit card and bank wire transfer as forms of payment for deposits results in those forms of payment being listed in the payment instructions 1410 of the payment instruction webpage 1400. The payment instructions webpage 1410 can include links associated with each payment type that lead an end user 108 to a webpage outside of the customized auction website to complete a payment. As will be understood, the subscriber 106 can customize the payment instruction webpage 1400 based in the subscriber's 106 preferences of the subscriber's understanding of the preferences of its end users 108.

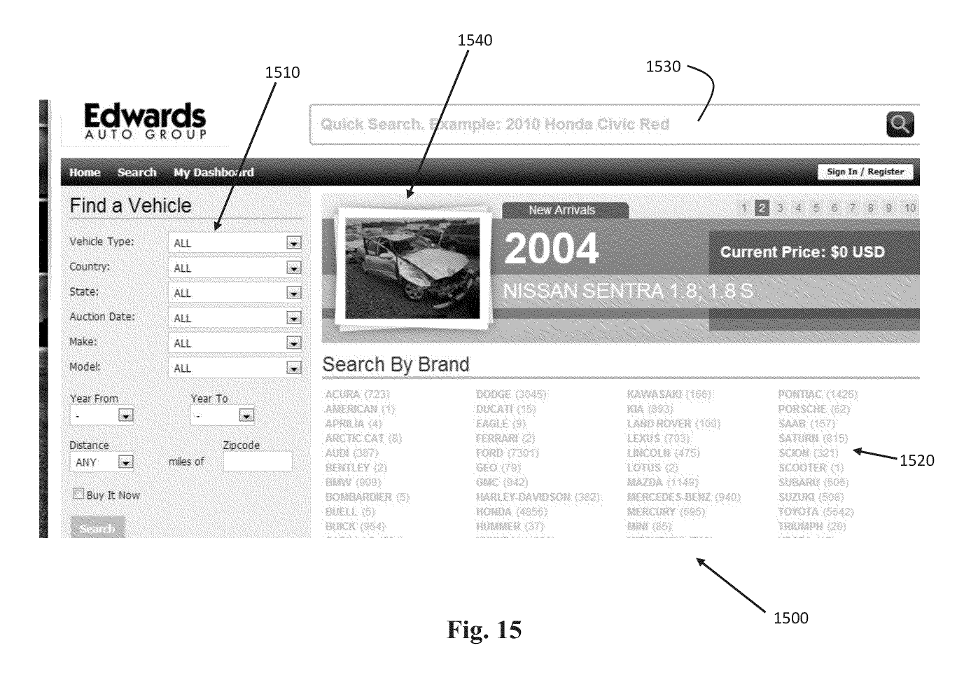

FIG. 15 illustrates an example customized auction website interface 1500 for displaying automobile auction inventory to an end user 108. Customized auction website interface 1500 enables an end user 108 to search for an automobile according to parameters defined by subscriber 106 using website settings interface 700. For example, end user 108 can search for an automobile according to make, model, year, and so on (see search fields 1510). End user 108 can also search for a particular brand by clicking on the brand name directly (see links 1520). The end user 108 can also use text to search for an automobile (see search box 1530). In addition, the subscriber 106 can upload promotional banners to prominently display promotional information, images, vehicle information, offers, advertisement, and other similar messages. Links can also be added to allow for the end user 108 to be redirected to another webpage by clicking on the promotional banner.

As previously noted, a subscriber 106, such as an auto dealer, can include its own inventory in the auction activities. The subscriber 106 may want to highlight or “feature” one of its own vehicles to the end user 108. In one embodiment, the customized auction website interface 1500 can include a featured vehicle section 1540 on the homepage or other prominent page. The featured vehicle section can be made visible to end users 108 when they visit the website 110 to direct more interest to the featured vehicles.

The system 100 can also provide for a subscriber 106a to expose its inventory on other subscriber's 106a, 106n custom auction website. Such cross-site marketing can provide for a subscriber 106a to display its own inventory not only on its own custom auction website 110a, but also on one or more other subscriber's 106b, 106n custom auction websites 110b, 110n. The system 100 can provide for one subscribers 106a inventory to be included on other subscribers' 106b, 106n custom auction websites 110b, 110n by selection variables such as geographic region, state, country, target market for website, etc. The system 100 can be arranged so that such cross-site marketing is controlled by an opt-in/opt-out option for displaying another subscriber's 106 auction items.

A subscriber 106 exposing its physical inventory to the auction activities in general can result in the subscriber 106a efficiently selling its own inventory to end users 108b, 108n it would otherwise not have access to. Without participating in a virtual auction, an auto dealer, for example, typically has to transport vehicles to a physical auction site. There is no guarantee that the vehicle will be sold. Therefore, the auto dealer is at risk of incurring the cost of transporting the vehicle to the physical auction and back again if unsold without realizing any revenue from sale of the vehicle. With the virtual auction the vehicle remains with the auto dealer until it is purchased. As will be understood, any shipping costs incurred after a vehicle is sold at a virtual auction can be charged to the purchaser or built into the pricing for the vehicle. Therefore, the auto dealer does not have to bear the risk of shipping costs.

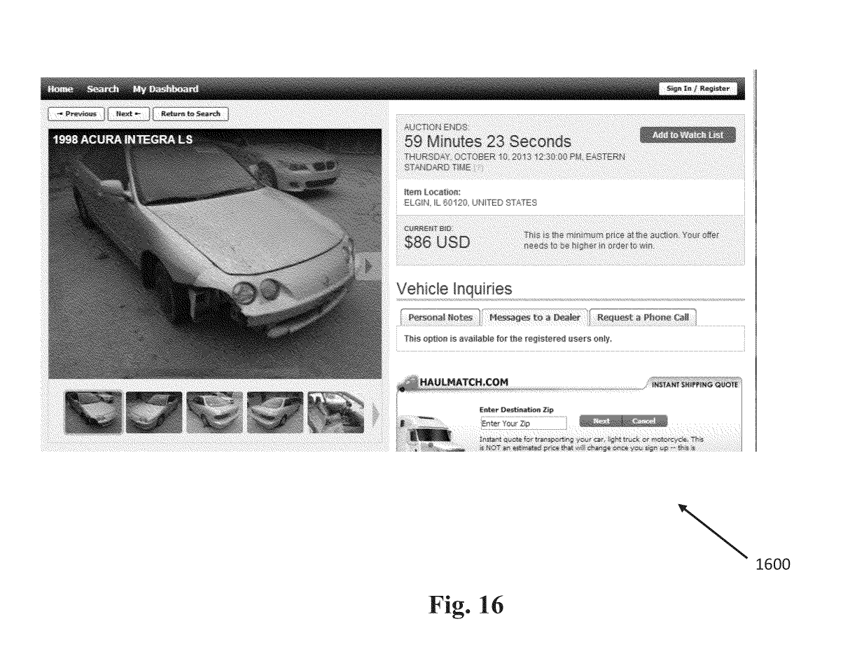

Referring again to FIG. 15, when end user 108 identifies and selects an auction item of interest via customized auction website interface 1500, an auction items detail interface 1600, as illustrated in FIG. 16, can be presented to the end user 108. Auction items detail interface 1600 can display detailed information about the auction item such as detailed description, photographs of the item, time remaining in the auction, location of the auction, the bid amount, and other suitable information about the item.

In one example, the auction items detail interface 1600 is continuously updated in real time with current bid information received by auction server 102 from auction providers 104 and subscribers 106 and their end users 108. In another example, the auction items detail interface 1600 is static and is not updated with bid information in real time. Instead, the auction items detail interface 1600 display a buy it now price or a staring bid amount. It will be understood that the items detail interface 1600 can be arranged to accommodate any number of sales models.

Auction items detail interface 1600 enables an end user 108 to communicate a desire to bid on an auction item. For example, an end user 108 can enter a maximum amount as a proxy bid and click submit to communicate the bid to the subscriber 106. In another example, the auction items detail interface 1600 enables the end user 108 to communicate a request to speak or otherwise communicate directly with the subscriber 106. The subscriber 106 can then call or email the end user 108 to discuss placing a bid on the auction item.

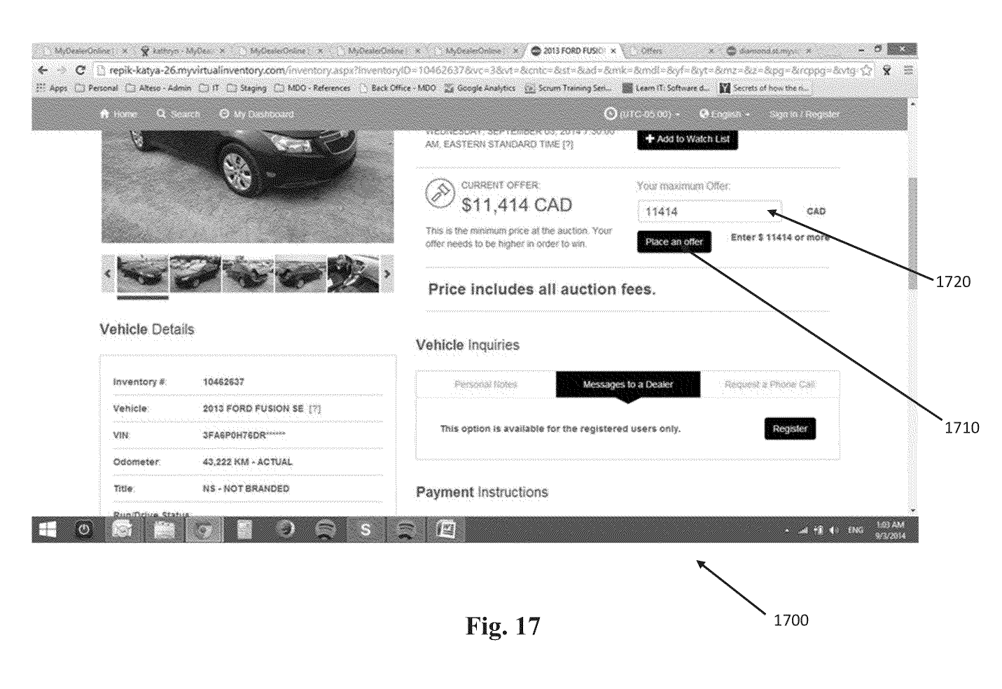

FIG. 17 illustrates another example of an auction item detail interface 1700, which includes a place-an-offer button 1710. The end user 108 can review the details of an auction item and compare against other auction items. When the end user 108 is prepared to make an offer on an auction item, the end user can enter a bid amount in the offer window 1720 and enter the bid by clicking on the place-an-offer button 1710. The bid can be forwarded to and possessed by the auction server 102. If the end user's bid is ultimately the highest bid, the end user will win the auction.

The auction items detail interfaces 1600, 1700 can also include a widget or other type of integrated application for added functionality such as a tool for offering the end user 108 instant information on auxiliary costs that may accompany a successful bid. For example, in the case of purchasing a vehicle, the tool can provide the costs for shipping or transporting the vehicle to the end user's 108 desired delivery location. In one example, the end user 108 can provide an address of zip code that is used by the tool to provide a shipping or transportation quote. In another example, a subscriber can add a profit margin to the shipping or transportation quote.

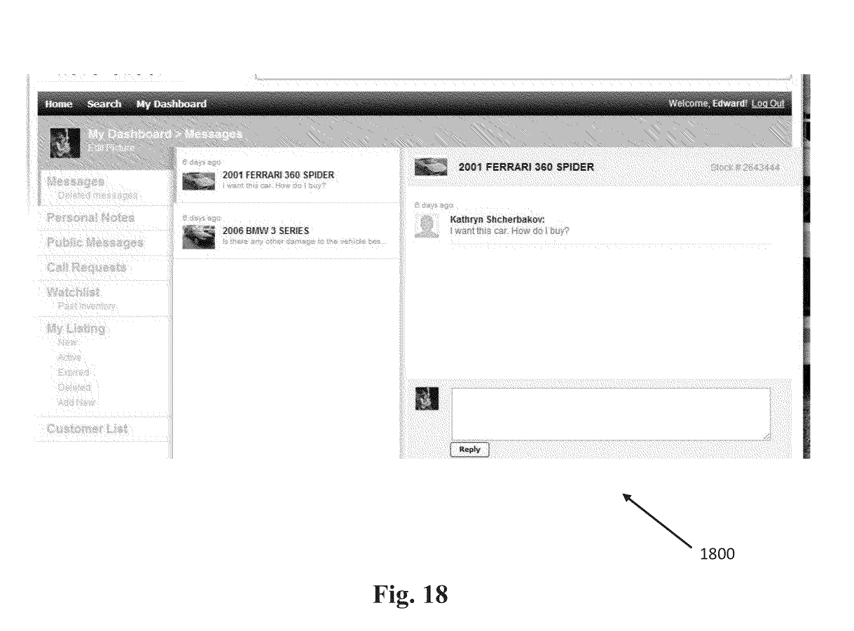

In order to view and process requests made by an end user 108, a subscriber 106, or an employee or agent of the subscriber 106 designated as an administrator by the subscriber 106, can access a dashboard interface 1800 as illustrated in FIG. 18. The dashboard interface 1800 enables the subscriber 106 and/or its designated administrator to view and manage auction inventory. In one example, the dashboard interface 1800 enables subscriber 106 to manage both physical inventory as well as virtual auction inventory.

The dashboard interface 1800 also enables a subscriber to view and reply to communications received from end users 108. For example, subscriber 106 can respond to an end user 108 and answer a question about an auction item via the dashboard interface 1800. A subscriber 106 can also confirm receipt of a request to submit a proxy bid for an auction item on behalf of an end user 108 via the dashboard interface 1800. Subscriber 106 can use any prequalification requirements for its buyers, such as deposit collection, bidding authorization, etc. In one example, a subscriber 106 can request a deposit to be paid, via a portal interface (not shown), upon submission of a bid on an auction item.

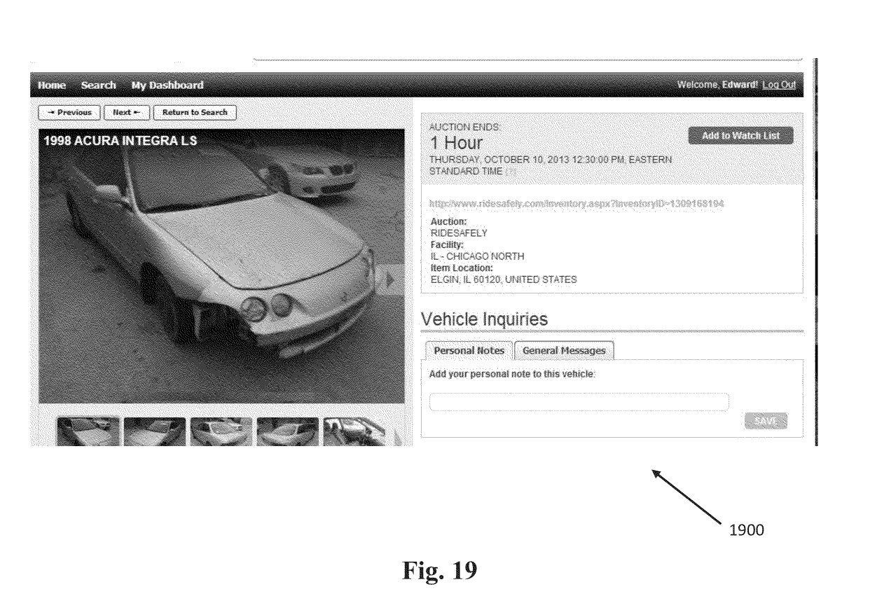

After a subscriber 106 receives a bid request from an end user 108, the subscriber 106 can place or forward a bid with the auction provider 104 on behalf of the end user 108, if the subscriber 106 is registered with the auction provider 104. Information regarding the auction provider 104 can be displayed in an administrative view of an auction items detail interface 1900, as illustrated in FIG. 19. The administrative view of an auction items detail interface 1900 can include a link for electronically submitting bids on an auction item to an auction provider 104. Alternatively, the administrative view of an auction item detail interface 1900 can include a telephone number for contacting the auction provider 104 in order to place a bid on an item. Having links for submitting bids for various auction items at multiple auction providers 104 available via one central portal improves subscriber's ability to place bids efficiently. The subscriber 106 can pre-qualify each end user 108 prior to placing any bids. Once pre-qualified, an end user's 108 bid placed on the customized auction website 110 can be automatically submitted to the auction server 102, provided that subscriber 106 provides login credentials to the system 100. This is to say that end user's 108 bids submitted via the customized auction website 110 can be forwarded to the auction server 102 along with the subscriber's 106 identification information and/or credentials so that auction providers 104 can verify any sale will be with a known subscriber 106.

Alternatively, if the subscriber 106 is not registered with the auction provider 104 and therefore unable to place a bid directly, the subscriber 106 can submit a bid to the auction provider 104 via a registered broker. This can be done with a telephone call to the registered broker, for example, or electronically. Accordingly, the administrative view of an auction items detail interface 1900 can include either a link to submit an electronic bid to a broker or a telephone number to contact the broker to submit a bid. Other suitable information for submitting a bid, either directly to the auction provider 104 or to a broker, can similarly be displayed in the administrative view of an auction items detail interface 1900.

Because bids are submitted by the subscriber 106, and end user 108 information is kept confidential, the auction provider 104 is not aware of the end user 108 and is therefore unable to circumvent the subscriber in order to sell auction items directly to the end user 108.

The dashboard interface 1800 can also be configured to provide notification to a subscriber 106 when a submitted bid is a winning bid. For example, auction server 102 can receive a notification from an auction provider 104 of a winning bid and then communicate the notification to the subscriber 106 that submitted the winning bid. The subscriber 106 can then communicate the notification to the end user 108 electronically via the dashboard interface 1800. For example, the subscriber 106 can trigger an email, a text message, or other suitable communication, via dashboard interface 1800, to inform the end user 108 of the winning bid. Or, the subscriber 106 can notify the consumer of the winning bid by telephone or by other suitable means. In one example, the auction server 102 can simultaneously notify the subscriber 106 and the end user 108 of the winning bid. Similarly, the subscriber 106 or the auction server 102 can notify an end user 108 of a losing bid when an end user's 108 bid was not the highest submitted.

The dashboard interface 1800 can be arranged so that the end user 108 receives notifications of auction items that may be of interest to the end user 108. For example, if the end user 108 has repeatedly viewed a particular style of automobile, or a specific make, model and year range of automobiles, the system can track such viewing history and post notifications on the dashboard interface 1800 to alert the end user 108 when new auction items are offered that fit the general profile of the end user's prior searches. In another example, the subscriber 106 can track the viewing history of end users 108 and provide notifications to suggest auction items to the end users. When a notification is posted to the dashboard interface 1800, a message can be sent to the end user via a personal computing device. For example, an email or text message can be sent to the end user for viewing on the end users smart phone.

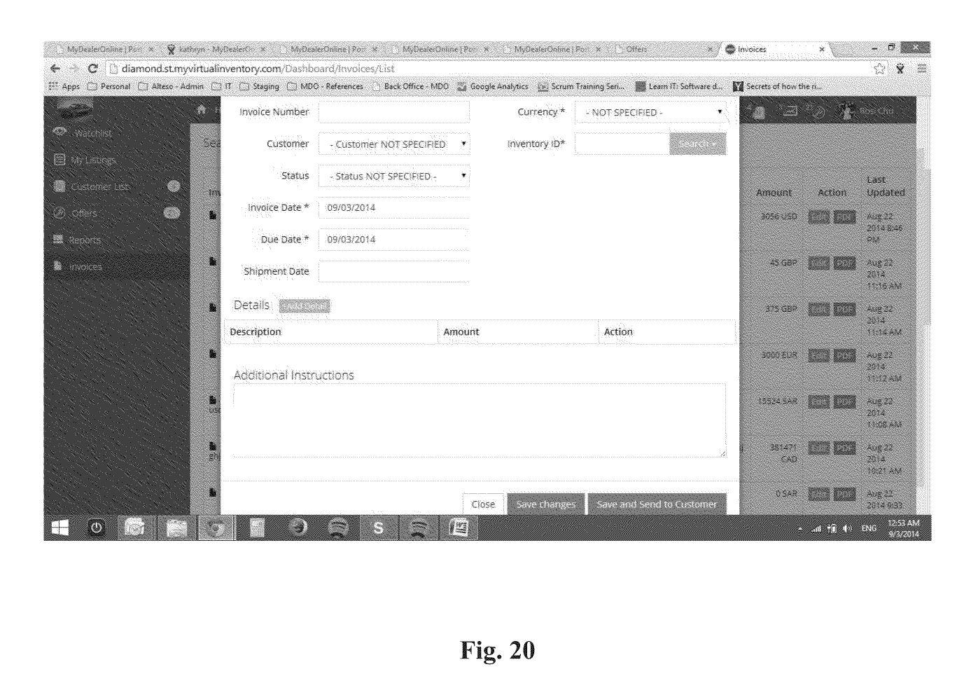

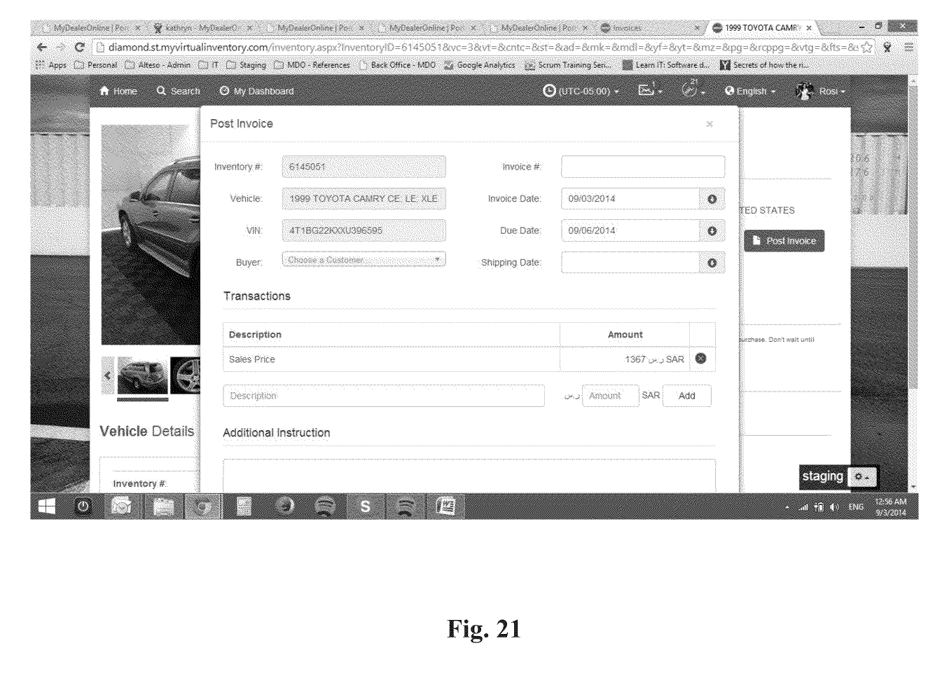

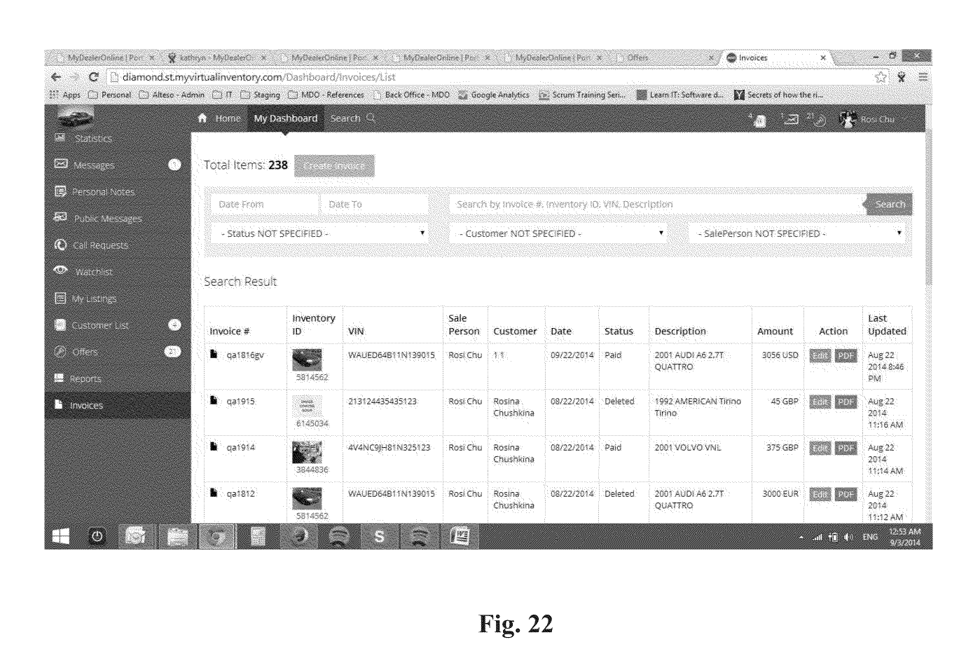

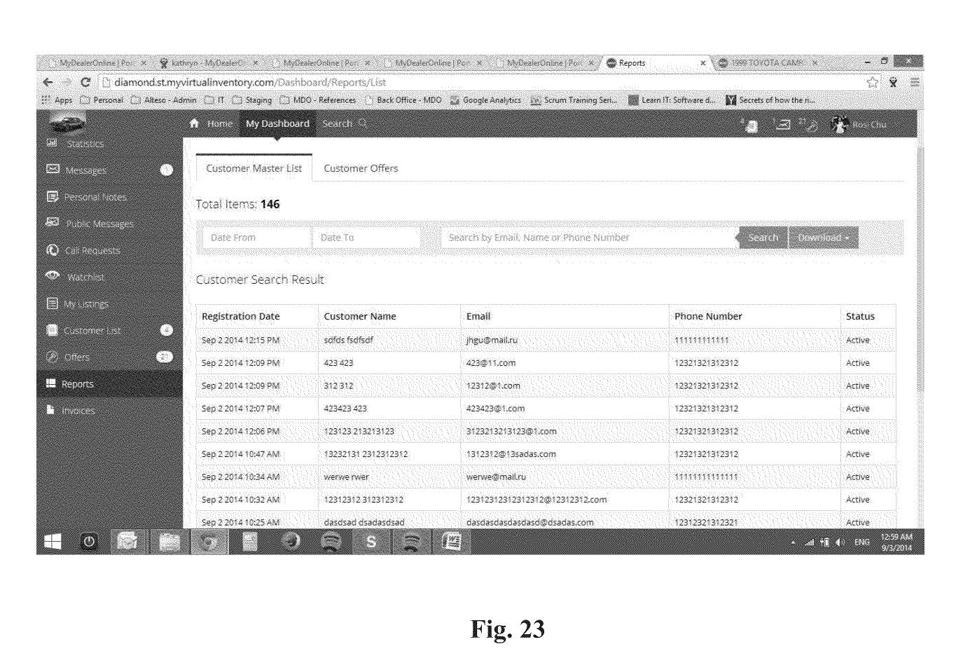

In one example, the dashboard interface 1800 also enables a subscriber 106 to generate an invoice and a bill of sale for a transaction and to communicate the invoice to the end user 108 via email or via other suitable means. The subscriber 106 can generate invoices to registered end users 108 from the dashboard interface or from an inventory detail page (see FIGS. 20 and 21). End user 108 can be notified that an invoice is available for viewing online. The system 100 allows the handling of electronic signatures, effectively allowing end user 108 to sign required paperwork from the dashboard interface. Such electronically signed paperwork can be stored in the system 100 for future reference and compliance. The invoicing system can help track purchases and transactions for both end user 108 and subscriber 106 (see FIG. 22). Easily searchable reports allow subscriber to access and download (in formats such as PDF, CSV, or other suitable formats) lists featuring created invoices, placed offers, master client list, and other relevant information are available for the subscriber 106 via a dashboard interface (see FIG. 23). Other documents can also be managed by the system 100. For example, the system can manage bills of sale, terms of use, privacy policies, salvage acknowledgements, buyers guides, and other relevant documents. Similar to the description of invoices, such documents electronically signed by end users 108 and can be stored on the system 100 for use when needed. In one example, dashboard interface 1800 can also enable a subscriber 106 to track and report sales expenses as well as sales which enables the subscriber 106 to efficiently track profits and losses.

In one embodiment, the subscriber 106 can customize the system 100 to manage documents in a manner specific to the subscriber's 106 needs or business model. For example, the system 100 can provide for the subscriber 106 to upload documents specific to and/or customized for the subscriber 106. In one example, if the subscriber 106 deals in salvaged vehicles, the subscriber 106 can upload a salvage acknowledgement document that will be presented to any end user 108 that purchases a salvaged vehicle. The system 100 can provide for the end user 108 to electronically sign the document and, thus, acknowledge that the end user 108 is aware that the vehicle is a salvaged vehicle. In another example, a subscriber 106 can provide its own “terms of use” document. The terms of use will be electronically presented to all the subscriber's 106 end users 108 for acceptance when the end users 108 use the subscriber's 106 customized auction website 110. It will be understood that the system 100 can be arranged to manage documents, i.e., upload, store, present to end users, etc., in a manner that can accommodate a variety of business models.

Once an auction item is won, the subscriber 106 can proceed with a transaction to transfer the item from the auction provider 104 to the end user 108 without the two parties having knowledge of each other. In one example, system 100 enables an end user 108 to pay subscriber 106 for an auction item directly using a debit card, credit card, a checking account, an online portal such as PayPal, or with any other suitable payment method defined by the subscriber 106. Similarly, system 100 also enables subscriber 106 to pay an auction provider 104 for the auction item or another subscriber 106, provided that other subscriber 106 provided the item for auction. Thus, payment can be streamlined between end user 108, subscriber 106, and auction provider 104.

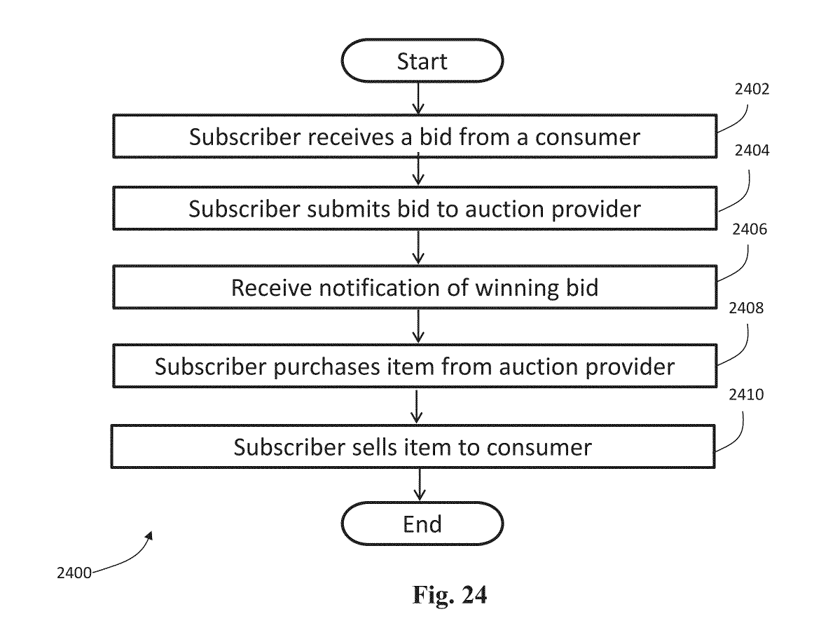

FIG. 24 illustrates the steps of a method 2400 for marketing and selling an auction item. At step 2402, an end user 108 submits a bid for an auction item to a subscriber 106. At step 2404, the subscriber 106 submits a proxy bid, on behalf of the end user 108, to the auction provider 104. At step 2406, the subscriber 106 receives notification that the end user 108 submitted a winning bid. At step 2408, the subscriber 106 completes the purchase of the auction item from the auction provider 104 without the auction provider 104 having any knowledge of the end user 108. At step 2410, the subscriber 106 completes a sale of the auction item to the end user 108 without the end user 108 having knowledge of the auction provider 104. Thus, two independent transactions take place where the subscriber 106 controls both transactions and neither party from the individual transactions have knowledge of each other.

The system can include an inventory management system that provides subscribers with tools to manage their own inventory of auction items as well as other manage item of other subscriber purchased by the subscriber's end users. For example, the system can track each of the subscriber's auction items to determine the subscriber's purchase price, sale price, number of days in inventory, profit per auction item, etc. The inventory management system can also track the profit on auction items purchased by end users through the subscriber, where the subscriber acts as a middle man. Additional metrics can be tracked by the system. For example, the system can track buying habits of the average user be tracking typically how long it takes for a registered end user to purchase its first item, the average items purchased by end user over time, the frequency at which end users search the auction website, etc.

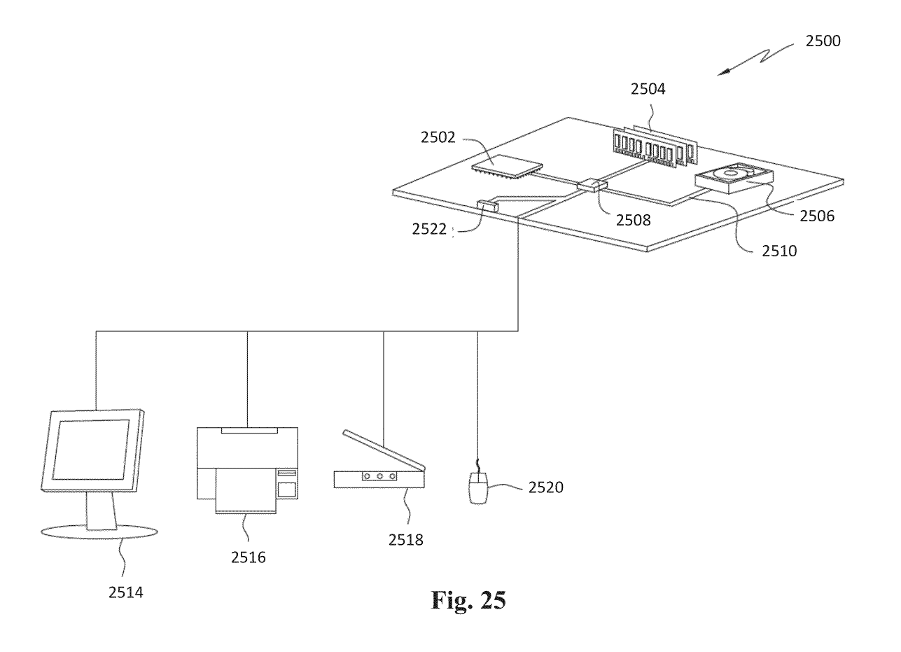

FIG. 25 is a block diagram of an example computing system 2500 for implementing an example system for marketing and selling an auction item. The example computing system 2500 is intended to represent various forms of digital computers, including laptops, desktops, handheld computers, smartphones, tablet computers, servers, and other similar types of computing devices. As shown, computing system 2500 includes a processor 2502, memory 2504, a storage device 2506, and a communication port 2522, operably connected by an interface 2508 via a bus 2510.

Processor 2502 processes instructions, via memory 2504, for execution within computing system 2500. In an example embodiment, multiple processors along with multiple memories may be used.

Memory 2504 may be volatile memory or non-volatile memory. Memory 2504 may be a computer-readable medium, such as a magnetic disk or optical disk. Storage device 2506 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 2504 or storage device 2506.

Computing system 2500 may be coupled to one or more input and output devices such as a display 2514, a printer 2516, a scanner 2518, and a mouse 2520.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

“Computing device,” as used herein, refers to a laptop computer, a desktop computer, a smartphone, a personal digital assistant, a cellular telephone, a tablet computer, an eReader, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners. One form of software is an app, or an application that executes on a mobile computing device such as a mobile phone.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

We claim:

1. A method for marketing and selling an auction item comprising the steps of:
providing a system for generating a customized auction website to facilitate access to an inventory of auction items;
receiving a request from a subscriber of the system to generate a customized auction website to provide access to the inventory of auction items for a user of the customized auction website;
generating the customized auction website according to subscriber specified parameters;
receiving a bid request for an auction item from a user of the customized auction website; and
communicating a response to the bid request to the user via the customized auction website.

2. The method of claim 1, wherein the inventory of auction items includes transportation vehicles.

3. The method of claim 1, wherein an auction house supplies items to the inventory of auction items.

4. The method of claim 3, wherein the subscriber supplies items to the inventory of auction items.

5. The method of claim 3, wherein the bid request from the user is communicated to the auction house.

6. The method of claim 5, wherein a response to the bid request is received from the auction house.

7. The method of claim 6, wherein if the bid request from the user is a winning bid, the response to the bid request includes an indication that the user is awarded the auction item.

8. The method of claim 7, wherein the subscriber takes ownership of the auction item upon the user being awarded the auction item.

9. The method of claim 8, wherein the subscriber transfers ownership of the auction item to the user.

10. The method of claim 8, wherein the user renders payment for the awarded auction item directly to the subscriber.

11. The method of claim 8, wherein the system receives payment from the user, and the system forwards a first portion of the payment to the auction house and forwards a second portion of the payment to the subscriber.

12. A method of marketing and selling auction items comprising the steps of:
providing a system for use by an auction house and a plurality of buyers;
arranging the system so that a customer associated with one of the plurality of buyers can review an auction inventory and place a bid on an auction item without knowing the identity of the auction house;
receiving a bid placed by the customer for the auction item;
forwarding the customer's bid to the auction house without the auction house knowing the identity of the customer;
receiving a response to the customer's bid from the auction house, where the response includes an indication of whether the customer's bid is a winning bid;
forwarding the response to the customer's bid to the customer;
the buyer associated with the customer taking ownership of the auction item if the customer's bid is the winning bid; and
the buyer transferring ownership of the auction item from the buyer to the customer.

13. The method of claim 12, wherein the method is facilitated by a website customized for each of the plurality of buyers.

14. The method of claim 13, wherein a customer of each buyer can view auction items and bid on auction items via the website customized for the buyer.

15. The method of claim 12, wherein a first buyer of the plurality of buyers supplies an auction item to the inventory of auction items.

16. The method of claim 15, wherein customers associated with a second buyer of the plurality of buyers can view and bid on the auction item supplied by the first buyer.

17. A method for marketing and selling an auction item comprising the steps of:
an auction house providing customized websites to a plurality of buyers;
each of the plurality of buyers providing access to the customized website to customers associated with the buyer;
receiving a bid on an auction item from a customer associated with one of the plurality of buyers;
responding to the bid, where the response to the bid includes an indication of whether the bid is a winning bid;
if the bid is the winning bid, transferring ownership of the auction item to the buyer associated with the customer.

18. The method of claim 17, where a first buyer of the plurality of buyers can supply an auction item.

19. The method of claim 18, where a customer associated with a second buyer can view and place a bid on the auction item supplied by the first buyer.

20. The method of claim 17, wherein a substantial portion of auction items are supplied by the plurality of buyers.
